(19) United States
(12) Patent Application Publication
(10) Pub. No.: US 2008/0137969 A1
(43) Pub. Date: Jun. 12, 2008

(54) Estimation of Within-Class Matrix in Image Classification

(75) Inventors: Daniel Rueckert, London (GB); Carlos Eduardo Thomaz, Sao Paulo (BR)

Correspondence Address: NEEDLE & ROSENBERG, P.C., SUITE 1000, 999 PEACHTREE STREET, ATLANTA, GA, 30309-3915, US

(73) Assignee: Imperial College Innovations Limited Electrical and Electronic Engineering Building, London (GB)

(21) Appl. No.: 11/547,755

(22) PCT Filed: Apr. 14, 2005
(86) PCT No.: PCT/GB05/01445

§ 371 Date: Oct. 6, 2006

(30) Foreign Application Priority Data
Apr. 14, 2004 (GB) 0408328.3
Sep. 23, 2004 (GB) 0421240.3

(51) Int. Cl. G06K 9/62

(52) U.S. Cl. 382/224

(57) ABSTRACT

For the classification of images, a classification measure is computed by registering a set of images to a reference image and performing linear discriminant analysis on the set of images using a conditioned within-class scatter matrix. The classification measure may be used for classifying images, as well as for visualising between-class differences for two or more classes of images.

The invention relates to a method of computing an image classification measure, and to apparatus for use in such a method.

Image processing techniques can be used to classify an image as belonging to one of a number of different classes (image classification) such as in automated recognition of hand-written postcodes which consists in classifying an image of a hand-written digit as representing the corresponding number. Recently, there has been increasing interest in applying classification techniques to medical images such as x-ray images of the breasts or magnetic resonance images of brain scans. The benefits of reliable automated image classification in the medical field is apparent in the potential of using such techniques for guiding a physician to a more reliable diagnosis.

In classification of images coming from a population of subjects from different groups (for example, healthy and ill) it is clear that images need to be mapped to a common coordinate system so that corresponding locations in the images correspond to the same anatomical features of the subjects. For example, in the analysis of brain scans, it is a prerequisite of any cross-subject comparison that the brain scans from each subject be mapped to a common stereotactic space by registering each of the images to the same template image.

Known approaches to the statistical analysis of brain images involve a voxel by voxel comparison between different subjects and/or conditions resulting in a statistical parametric map, which essentially presents the results of a large number of statistical tests. An example of such an approach is “Voxel-based morphometry—the methods” by J. Ashburner and K. J. Friston in Neuro-Image 11, pages 805 to 821, 2000.

In addition to the voxel-wise analysis discussed above, anatomical differences may be analysed by looking at the transformations required to register images from different subjects to a common reference image: see for example “Identifying Global Anatomical Differences: Deformation-Based Morphometry” by J. Ashburner et al, Neural Brain Mapping, pages 348 to 357, 1998.

Since it is unlikely that individual voxels will correlate significantly with the differences in brain anatomy between groups of subjects, a true multi-variate statistical approach is required for classification, which takes account of the relationship between the ensemble of voxels in the image and the different groups of subjects or conditions. Given the very large feature space associated with three-dimensional brain images at a reasonable resolution, prior art approaches relied on techniques such as Principle Component Analysis (PCA) to reduce the dimensionality of the problem. However, when the number of principle components used in the subsequent analysis is smaller than the rank of the covariance matrix of the data, the resulting loss of information may not be desirable.

The invention is set out in the claims. By applying linear discriminant analysis to image data registered to a common reference image using a suitably conditioned within-class scatter matrix, the dimensionality of the feature space that can be handled is increased. As a result, dimensionality reduction by PCA may not be necessary or may only be necessary to a lesser degree than without conditioning. This enables the use of more of the information contained even in very high dimensional data sets, such as the voxels in a brain image.

An embodiment of the invention will now be described, by way of example only and with reference to the drawings in which:

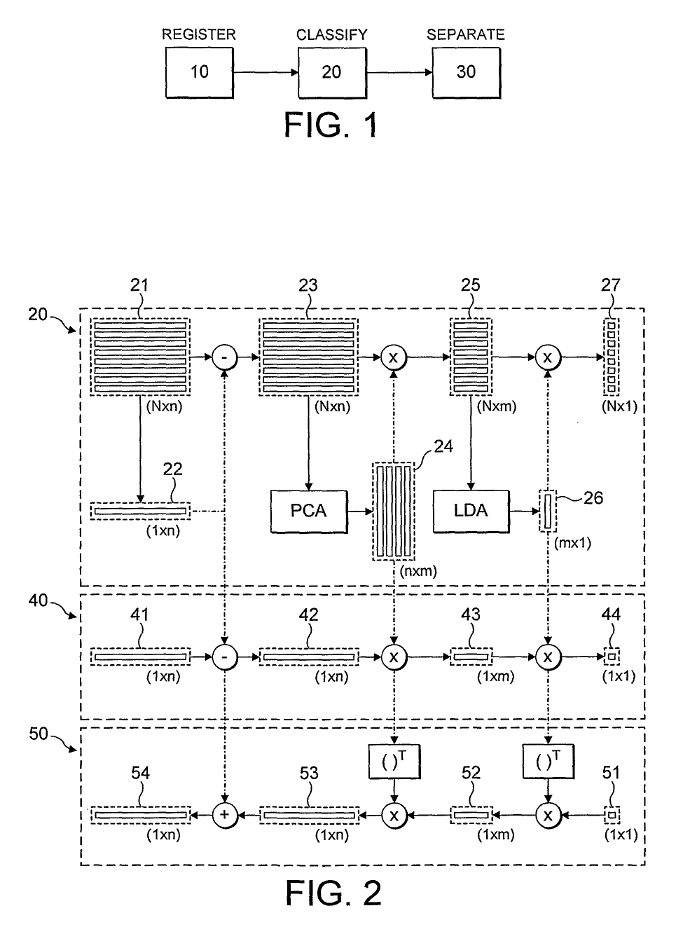

FIG. 1 shows an overview of a classification method according to an embodiment of the invention; and

FIG. 2 is a block diagram illustrating the calculation of a classification measure of the method of FIG. 1.

In overview, the embodiment provides a method of classifying an image as belonging to one of a group of images, for example classifying a brain scan as coming from either a pre-term child or a child born at full-term. With reference to FIG. 1, the images from all groups under investigation are registered to a common reference image at step 10, a classification measure is calculated at step 20 for each image and a classification boundary separating the different groups of images is calculated at step 30.

Given a set of images to be analysed, the first step 10 of registration comprises mapping images to a common coordinate system so that the voxel-based features extracted from the images correspond to the same anatomical locations in all images (in the case of brain images, for example). The spatial normalisation step is normally achieved by maximising the similarity between each image and a reference image by applying an affine transformation and/or a warping transformation, such as a free-form deformation. Techniques for registering images to a reference image have been disclosed in “Nonrigid Registration Using Free-Form Deformations: Application to Breast MR Images”, D. Rueckert et al, IEEE Transactions on Medical Imaging, Vol. 18, No. 8, August 1999 (registration to one of the images as a reference image) and “Consistent Groupwise Non-Rigid Registration for Atlas Construction”, K. K. Bhatia, Joseph V. Hajnal, B. K. Puri, A. D. Edwards, Daniel Rueckert, Proceedings of the 2004 IEEE International Symposium on Biomedical Imaging: From Nano to Macro, Arlington, Va., USA, 15-18 Apr. 2004. IEEE 2004, 908-911 (registering to the average image by applying a suitable constraint to the optimisation of similarity), both of which are incorporated herein by reference.

Once the images have been registered, that is aligned into a common coordinate system, features can be extracted for the purpose of classification. The feature can be defined as vectors containing the intensity values of pixels/voxels of each respective image and/or the corresponding coefficients of the warping transformation. For example, considering a two-dimensional image to illustrate the procedure of converting images into feature vectors, an input image with n 2-D pixels (or 3-D voxels) can be viewed geometrically as a point in an n-dimensional image space. The coordinates at this point represent the values of each intensity value of the images and form a vector xT=[x1, x2, x3 . . . xn] obtained by concatenating the rows (or columns) of the image matrix and where xT is the transpose of the column vectors x. For example, concatenating the rows of a 128×128 pixel image results in a feature vector in a 16,384-dimensional space. The feature vector may be augmented by concatenating with the parameters of the warping transformation or, alternatively, the feature vector may be defined with reference to the parameters for the warping transformation and not with reference to the intensity values.

Once feature vectors have been defined for the images, a classification measure is computed at step 20, using Linear Discriminant Analysis (LDA) as described in more detail below.

The primary purpose of Linear Discriminant Analysis is to separate samples of distinct groups by maximising their between-class separability while minimising their within-class variability. Although LDA does not assume that the populations of the distinct groups are normally distributed, it assumes implicitly that the true covariance matrices of each class are equal because the same within-class scatter matrix is used for all the classes considered.

Let the between-class scatter matrix S_{b} be defined as

$${S}_{b} = {\sum }_{i = 1}^{g} {N}_{i} ( {\overline{x}}_{i} - \overline{x} ) {( {\overline{x}}_{i} - \overline{x} )}^{T} \qquad ( 1 )$$

and the within-class scatter matrix S_{w} be defined as

$${S}_{w} = {\sum }_{i = 1}^{g} ( {N}_{i} - 1 ) {S}_{i} = {\sum }_{i = 1}^{g} {\sum }_{j = 1}^{{N}_{1}} ( {x}_{i , j} - {\overline{x}}_{i} ) {( {x}_{i , j} - {\overline{x}}_{i} )}^{T} , \qquad ( 2 )$$

where x_{i,j} is the n-dimensional pattern j from class πᵢ, Nᵢ is the number of training patterns from class πᵢ, and g is the total number of classes or groups. The vector x̅ᵢ and matrix Sᵢ are respectively the unbiased sample mean and sample covariance matrix of class πᵢ. The grand mean vector x̅ is given by

$$\overline{x} = \frac{1}{N} {\sum }_{i = 1}^{g} {N}_{i} {\overline{x}}_{i} = \frac{1}{N} {\sum }_{i = 1}^{g} {\sum }_{j = 1}^{{N}_{1}} {x}_{i , j} , \qquad ( 3 )$$

where N is the total number of samples, that is, N=N₁+N₂+ . . . +N_{g}. It is important to note that the within-class scatter matrix S_{w} defined in equation (2) is essentially the standard pooled covariance matrix multiplied by the scalar (N−g), that is

$${S}_{w} = {\sum }_{i = 1}^{g} ( {N}_{i} - 1 ) {S}_{i} = ( N - g ) {S}_{p} . \qquad ( 4 )$$

The main objective of LDA is to find a projection matrix P_{lda} that maximizes the ratio of the determinant of the between-class scatter matrix to the determinant of the within-class scatter matrix (Fisher's criterion), that is

$${P}_{lda} = {arg max}_{P} \frac{\vert {P}^{T} {S}_{b} P \vert}{\vert {P}^{T} {S}_{w} P \vert} . \qquad ( 5 )$$

It has been shown that P_{lda} is in fact the solution of the following eigensystem problem:

S_{b}P−S_{w}PA=0. (6)

Multiplying both sides by S_{w}⁻¹, equation (6) can be rewritten as

S_{w}⁻¹S_{b}P−S_{w}⁻¹S_{w}PΛ=0

S_{w}⁻¹S_{b}P−PΛ=0

(S_{w}⁻¹S_{b})P=PΛ (7)

where P and Λ are respectively the matrices of eigenvectors and eigenvalues of S_{w}⁻¹S_{b}. In other words, equation (7) states that if S_{w} is a non-singular matrix then the Fisher's criterion described in equation (5) is maximised when the projection matrix P_{lda} is composed of the eigenvectors of S_{w}⁻¹S_{b} with at most (g−1) nonzero corresponding eigenvalues. This is the standard LDA procedure.

The performance of the standard LDA can be seriously degraded if there are only a limited number of total training observations N compared to the dimension of the feature space n. Since the within-class scatter matrix S_{w} is a function of (N−g) or less linearly independent vectors, its rank is (N−g) or less. Therefore, S_{w} is a singular matrix if N is less than (n+g), or, analogously, may be unstable if N is not at least five to ten times (n+g).

In order to avoid both the singularity and instability critical issues of the within-class scatter matrix S_{w} when LDA is used in limited sample and high dimensional problems such as medical imaging, an approach based on a non-iterative covariance selection method for the S_{w} matrix has been suggested previously for a face-recognition application: Imperial College, Department of Computing technical report 2004/1, “A Maximum Uncertainty LDA-Based Approach for Limited Sample Size Problems with Application to Face Recognition”, Carlos E. Thomaz, Duncan F. Gillies, http://www.doc.ic.ae.uk/research/technicalreports/2004/.

The idea is to replace the pooled covariance matrix Sₚ of the scatter matrix S_{w} (equation (4)) with a ridge-like covariance estimate of the form

Ŝₚ(k)=Sₚ+kI, (8)

where I is the n by n identity matrix and k≧0.

The proposed method considers the issue of stabilising the Sₚ estimate with a multiple of the identity matrix by selecting the largest dispersions regarding the Sₚ average eigenvalue.

Following equation (8), the eigen-decomposition of a combination of the covariance matrix Sₚ and the n by n identity matrix I can be written as

$$\begin{matrix}{{S}^{⋒}}_{p} ( k ) = {S}_{p} + kI \\ = {\sum }_{j = 1}^{r} {λ}_{j} {{φ}_{j} ( {φ}_{j} )}^{T} + k {\sum }_{j = 1}^{n} {{φ}_{j} ( {φ}_{j} )}^{T} \\ = {\sum }_{j = 1}^{r} ( {λ}_{j} + k ) {{φ}_{j} ( {φ}_{j} )}^{T} + {\sum }_{j = r + 1}^{n} k {{φ}_{j} ( {φ}_{j} )}^{T}\end{matrix} \qquad ( 9 )$$

where r is the rank of Sₚ(r≦n), λⱼ is the jth non-zero eigenvalue of Sₚ, φⱼ is the corresponding eigenvector, and k is an identity matrix multiplier. In equation (9), the following alternative representation of the identity matrix in terms of any set of orthonormal eigenvectors is used

$$I = {\sum }_{j = 1}^{n} {{φ}_{j} ( {φ}_{j} )}^{T} . \qquad ( 10 )$$

As can be seen from equation (9), a combination of Sₚ and a multiple of the identity matrix I as described in equation (8) expands all the Sₚ eigenvalues, independently whether these eigenvalues are either null, small, or even large.

Since the estimation errors of the non-dominant or small eigenvalues are much greater than those of the dominant or large eigenvalues the following selection algorithm expanding only the smaller and consequently less reliable eigenvalues of Sₚ, and keeping most of its larger eigenvalues unchanged is an efficient implementation of conditioning S_{w}:

i) Find the Φ eigenvectors and A eigenvalues of Sₚ, where Sₚ=S_{w}/[N−g];

ii) Calculate the Sₚ average eigenvalue λ̅, using

$$\overline{λ} = \frac{1}{n} {\sum }_{j = 1}^{n} {λ}_{j} = \frac{tr ( {S}_{p} )}{n} ,$$

where the notation “tr” denotes the trace of a matrix.

iii) Form a new matrix of eigenvalues based on the following largest dispersion values

Λ*=diag[max(λ₁, λ̅),max(λ₂, λ̅), . . . , max(λₙ, λ̅)]; (11a)

iv) Form the modified within-class scatter matrix

S_{w}*=Sₚ*(N−g)=(ΦΛ*Φ^{T})(N−g). (11b)

Of course, S*_{W} can also be calculated directly by calculating Λ* for the eigenvalues of S_{W} and using S*_{W}=Φ′Λ′*Φ′^{T} where Φ′ and Λ′ are the eigenvector and eigenvalue matrices of S_{W}.

The conditioned LDA is then constructed by replacing S_{w} with S_{w}* in the Fisher's criterion formula described in equation (5). It is a method that overcomes both the singularity and instability of the within-class scatter matrix S_{w} when LDA is applied directly in limited sample and high dimensional problems.

The main idea of the proposed LDA-based method can be summarised as follows. In limited sample size and high dimensional problems where the within-class scatter matrix is singular or poorly estimated, it is reasonable to expect that the Fisher's linear basis found by minimizing a more difficult “inflated” within-class S*_{W} estimate would also minimize a less reliable “shrivelled” within-class S*_{W} estimate.

Since the features vectors used in image classification in fields such as medical brain imaging may be of extremely high dimensionality (more than 1 million voxel intensity values and/or more than 5 millions parameters of the warping transformation) it may be necessary to reduce the dimensionality of the feature vector, for example by projecting into a subspace using Principle Component Analysis (PCA). However, it should be noted that, where memory limitations are not an issue, reducing the dimensionality of the problem would not be paramount because the conditioning of S*_{W} deals with the singularity of the within-class scatter matrix. This is in contrast to other classification methods, such as the Fischer faces method, which relies on PCA to ensure the numerical stability of LDA.

The total number of principal components to retain for best LDA performance should be equal to the rank of the total scatter matrix S_{T}=S_{w}+S_{b}. When the total number of training examples N is less than the dimension of the original feature space n, the rank of S_{T} can be calculated as

$$\begin{matrix}rank ( {S}_{T} ) \leq rank ( {S}_{w} ) + rank ( {S}_{b} ) \\ \leq ( N - g ) + ( g - 1 ) \\ \leq N - 1.\end{matrix} \qquad ( 12 )$$

In order to avoid the high memory rank computation for large scatter matrices and because the conditioned S*_{W} deals with the singularity of the within-class scatter matrix, equation (12) allows the assumption that the rank of S_{T} is N−1. Since this is an upper bound on the rank of S_{T}, retaining N−1 principal components is conservative in terms of information retained, as well as safe, given that the conditioning of S_{W} takes care of numerical stability.

The process step 20 N n-dimensional of computing a classification measure is now described in detail with reference to FIG. 2A, N×n data matrix 21 is formed by concatenation of the N n-dimensional feature vectors and the mean feature vector 22 is subtracted to form the zero-mean data matrix 23. If required, the zero-mean data matrix 23 is projected onto a PCA subspace defined by the m largest eigenvectors 24 using PCA. This results in a reduced dimensionality data matrix 25 of N m-dimensional feature vectors, which are referred to as the most expressive feature vectors.

In the example shown in FIG. 2, there are only two classes of images and, accordingly, LDA results in a linear discriminant subspace of only one dimension corresponding to the single eigenvector 26 using LDA. The most discriminant feature of each image is found by projecting the reduced dimensionality data matrix 25 on to the eigenvector 26 to give a classification measure 27 consisting of one value for each image.

In addition to calculating the classification measure, an image classifier requires the definition of a classification boundary (step 30). Images lying to one side of the image classification boundary in the linear discriminant subspace defined by eigenvector (or eigenvectors) 26 are assigned to one class and images lying on the other side are assigned to the other class. Methods for defining the classification boundary on the linear discriminant subspace are well-known in the art, and the skilled person will be able to pick an appropriate one for the task at hand. For example, an Euclidean distance measure defined in the linear discriminant subspace as the Euclidean distance between the means of the different classes can be used to define a decision boundary. In the example of only two classes, the linear subspace will be one-dimensional and the decision boundary becomes a threshold value halfway between the means of the linear discriminant features for each class. Images having a linear discriminant feature above the threshold will be assigned to the class having the higher mean and images having a liner discriminant feature below the threshold will be assigned the class having the lower mean.

Once the classification method has been set up as described above it can be used to classify a new image for which a class label is not known. This is now described with reference to step 40 in FIG. 2. A feature vector 41 corresponding to a new, unlabeled image, is analysed by subtracting a mean feature vector 22 to form a mean-subtracted feature vector 42 which in turn is then projected into the PCA subspace to form the dimensionality reduced feature vector 43, which is projected onto the linear discriminant subspace to result in the linear discriminant feature 44 of the corresponding image. In the example, discussed above, of only two possible classes, this would be a single value and a new image can be classified by comparing this value to the classification boundary (or threshold) of method step 30.

In addition to computational efficiency, the use of a linear classifier has the added advantage that visualising (step 50) the linear discriminant feature space is conceptually and computationally very easy. Starting with a linear discriminant feature 51 in the linear discriminant subspace, the feature is multiplied by the transpose of eigenvector(s) 26 to project onto the corresponding most expressive feature vector 52, which is then multiplied by the transpose of the eigenvector(s) 24 to project back into the original space to form a corresponding feature vector 53. After addition of the mean feature vector 22 to form the feature vector 54 representing the image corresponding to the linear discriminant feature 51, the corresponding image can then be displayed by rearranging the feature vector into an image. Thus, by visually studying the image of a reconstituted feature vector 54 corresponding to a linear discriminant feature 51, the visual features that discriminate between the classes can be studied.

For example, the value of the linear discriminant feature 51 can be varied continuously and the changes in the resulting image can be observed or images at several points in the linear discriminant feature space can be displayed simultaneously and compared by eye. Images at the population mean of linear discriminant feature 51 and corresponding multiples of the standard deviation may preferably be displayed simultaneously to give an idea of distribution of visual features from one class to the other.

Although the embodiment described above refer mostly to the analysis of brain images, the invention is applicable to image classification in general, for example, in face recognition or digit classification. In particular, the method is applicable to any kind of medical image, such as (projective) x-ray images, CAT scans, ultrasound imaging, magnetic resonance imaging and functional magnetic resonance imaging. It will be appreciated that the approach can be applied to classification of images in two dimensions or three dimensions or in addition incorporating a time dimension, as appropriate.

The approach can be implemented in any appropriate manner, for example in hardware, or software, as appropriate. In view of the potential computational burden of the approach, the method can be distributed across multiple intercommunicating processes which may be remote from one another.

Having described a particular embodiment of the present invention, it is to be appreciated that the embodiment in question is exemplary only and that alterations and modifications, such as will occur to those of appropriate knowledge and skills, may be made without departure from the scope and spirit of the invention as set forth in the appended claims.

1. A method of computing an image classification measure comprising:
a) automatically registering a set of images, each belonging to one or more of a plurality of classes, to a reference image using affine or free-form transformations, or both;
b) calculating a within-class scatter matrix from the set of images;
conditioning the within-class scatter matrix such that its smallest eigenvalue is larger than or equal to the average of its eigenvalues; and
c) performing linear discriminant analysis using the conditioned within-class scatter matrix to generate an image classification measure.

2. A method as claimed in claim 1, wherein the within-class scatter matrix is conditioned using a modified eigenvalue decomposition replacing eigenvalues smaller than the average eigenvalue with the average eigenvalue.

3. A method as claimed in any one of the preceding claims, the images being medical images.

4. A method as claimed in claim 3, the images being computer-aided tomography images, magnetic resonance images, functional magnetic resonance images, ultrasound images or x-ray images.

5. A method as claimed in any one of the preceding claims, the images being images of brains.

6. A method as claimed in any one of the preceding claims, wherein calculating the within-class scatter matrix comprises defining an image vector representative of each image in an image vector space; and in which performing the linear discriminant analysis comprises projecting the image vector into a linear discriminant subspace.

7. A method as claimed in claim 6, the image vector being representative of intensity values or parameters of the free-form transformation used for registration, or both.

8. A method as claimed in claim 6 or 7, wherein the vector is projected into a PCA subspace using PCA prior to a projection into the linear discriminate subspace.

9. A method as claimed in claim 8, wherein the dimensionality of the PCA subspace is smaller than or equal to the rank of the total scatter matrix of the image vectors.

10. A method as claimed in claim 9, wherein the dimensionality of the PCA subspace is equal to the rank of the total scatter matrix.

11. A method of classifying an image comprising computing a classification measure as claimed in any of the preceding claims and classifying the image in dependence upon the classification measure.

12. A method of visualising between-class differences for two or more classes of images using a method of computing a classification measure as claimed in any of claims 6 to 10, the method of visualising comprising selecting a point in the linear discriminant subspace, projecting that point into the image vector space and displaying the corresponding image.

13. A method of visualising as claimed in claim 12, the method comprising selecting a plurality of points in the linear discriminant subspace and simultaneously displaying the corresponding images.

14. A computer system arranged to implement a method of computing a classification measure as claimed in any one of claims 1 to 10, or a method of classifying an image as claimed in claim 11, or a method of visualising as claimed in claims 12 or 13.

15. A computer-readable medium carrying a computer program comprising computer code instructions for implementing a method of computing a classification measure as claimed in any one of claims 1 to 10, or a method of classifying an image as claimed in claim 11, or a method of visualising as claimed in claims 12 or 13.

16. An electromagnetic signal representative of a computer program comprising computer code instructions for implementing a method of computing a classification measure as claimed in any one of claims 1 to 10, or a method of classifying an image as claimed in claim 11, or a method of visualising as claimed in claims 12 or 13.
